(19) United States
(12) Patent Application Publication
(10) Pub. No.: US 2013/0246520 A1
(43) Pub. Date: Sep. 19, 2013

(54) Recognizing Social Media Posts, Comments, or other Texts as Business Recommendations or Referrals

(71) Applicants: Marcus Lee Belvin, Raleigh, NC (US); Kelly Ann Gani, Austin, TX (US); Matthew Charles Hillary, Tyler, TX (US); Kimberly Dawn McCall, Leander, TX (US); Henri Fouotsop Meli, Cary, NC (US)

(72) Inventors: Marcus Lee Belvin, Raleigh, NC (US); Kelly Ann Gani, Austin, TX (US); Matthew Charles Hillary, Tyler, TX (US); Kimberly Dawn McCall, Leander, TX (US); Henri Fouotsop Meli, Cary, NC (US)

(73) Assignee: International Business Machines Corporation, Armonk, NY (US)

(21) Appl. No.: 13/420,965

(22) Filed: Mar. 15, 2012

(51) Int. Cl. G06F 15/16

(52) U.S. Cl. 709/204

(57) ABSTRACT

An approach is provided that receives social network feeds at a network interface. Each of the feeds is a freeform comment. The feeds are analyzed in order to identify keywords that are included in any of the social network feeds. A keyword found in a social network feed indicates the presence of contact data in the social network feed. When a keyword is found, contact data is extracted from the selected social network feed and the extracted data is stored in a contact-oriented application.

### TECHNICAL FIELD

The present invention relates to data analysis and retention as such relates to automatic extraction of business information from freeform textual entries.

### BACKGROUND OF THE INVENTION

Traditional networked information systems, such as social media websites and the like, often provide efficient means for exchanging information between users over a computer network, such as the Internet. Users can post comments using these websites that might pertain to a business referral or recommendation. While the user may wish to capture and retain such data, using traditional systems the user resorts to manual methods, such as copying the text from the social media website and pasting it into another application, such as the user's contact application (e.g., personal information manager (PIM), etc.) or other storage location on the user's computer system. While copying and pasting the information allows for subsequent use of the information, no additional social relationship created with this method and the information that is being extracted cannot be easily stored in the social media website. Moreover, the user must visually recognize that a particular comment, or “post,” contains potentially useful information in order to capture the information. Failure to visually read a particular comment or post means that the data cannot be captured using traditional interfaces provided on current social media websites.

### SUMMARY

According to one embodiment of the present invention, an approach is provided that receives social network feeds at a network interface. Each of the feeds is a freeform comment. The feeds are analyzed in order to identify keywords that are included in any of the social network feeds. A keyword found in a social network feed indicates the presence of contact data in the social network feed. When a keyword is found, contact data is extracted from the selected social network feed and the extracted data is stored in a contact-oriented application.

The foregoing is a summary and thus contains, by necessity, simplifications, generalizations, and omissions of detail; consequently, those skilled in the art will appreciate that the summary is illustrative only and is not intended to be in any way limiting. Other aspects, inventive features, and advantages of the present invention, as defined solely by the claims, will become apparent in the non-limiting detailed description set forth below.

### BRIEF DESCRIPTION OF THE DRAWINGS

The present invention may be better understood, and its numerous objects, features, and advantages made apparent to those skilled in the art by referencing the accompanying drawings, wherein:

FIG. 1 is a block diagram of a data processing system in which the methods described herein can be implemented;

FIG. 2 provides an extension of the information handling system environment shown in FIG. 1 to illustrate that the methods described herein can be performed on a wide variety of information handling systems which operate in a networked environment;

FIG. 3 is a block diagram depicting data feeds entering a social media website and a data monitor extracting and retaining useful information from the various feeds;

FIG. 4 is a flowchart depicting steps taken by a user to setup the data monitor functionality;

FIG. 5 is a flowchart depicting steps taken by the data monitor to parse and analyze data feeds;

FIG. 6 is a flowchart depicting steps taken by the data monitor to analyze and retain useful data extracted from the data feeds;

FIG. 7 is a flowchart depicting steps taken to provide extracted data to external applications outside of the social media website; and

FIG. 8 is a flowchart showing steps performed in extracting calendar-related information from a data feed to update the user's computer-based calendar.

### DETAILED DESCRIPTION

Certain specific details are set forth in the following description and figures to provide a thorough understanding of various embodiments of the invention. Certain well-known details often associated with computing and software technology are not set forth in the following disclosure, however, to avoid unnecessarily obscuring the various embodiments of the invention. Further, those of ordinary skill in the relevant art will understand that they can practice other embodiments of the invention without one or more of the details described below. Finally, while various methods are described with reference to steps and sequences in the following disclosure, the description as such is for providing a clear implementation of embodiments of the invention, and the steps and sequences of steps should not be taken as required to practice this invention. Instead, the following is intended to provide a detailed description of an example of the invention and should not be taken to be limiting of the invention itself. Rather, any number of variations may fall within the scope of the invention, which is defined by the claims that follow the description.

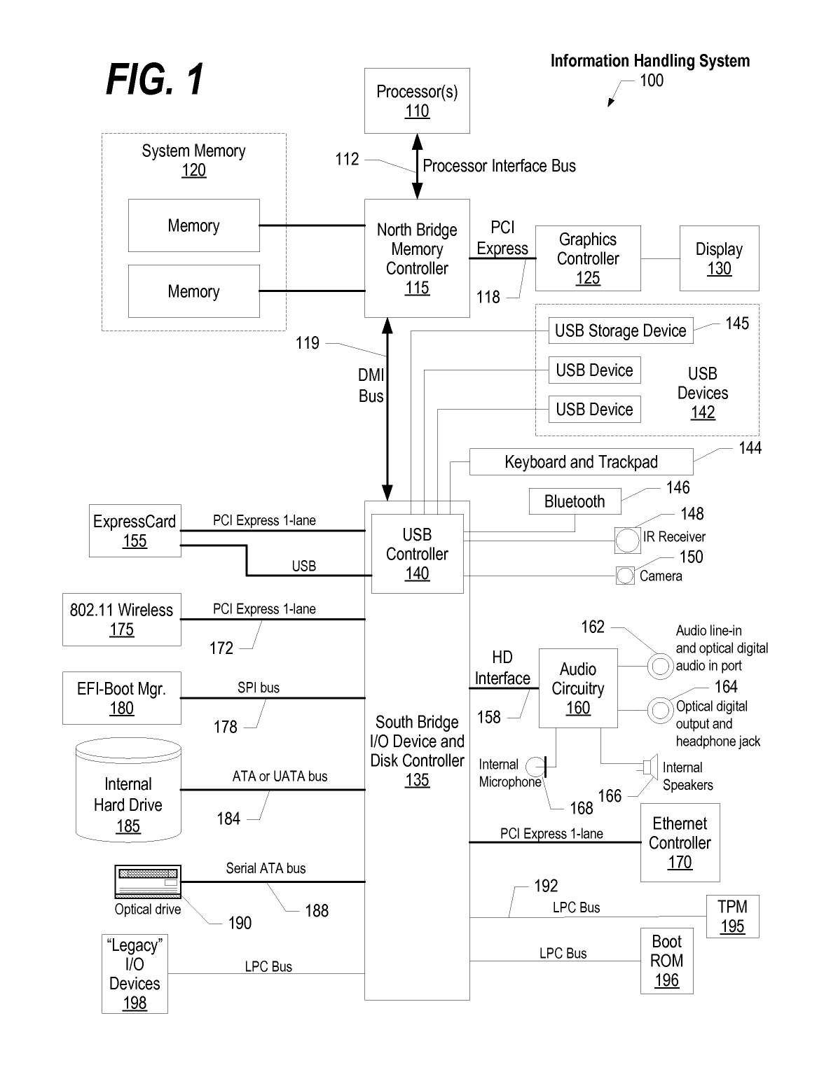

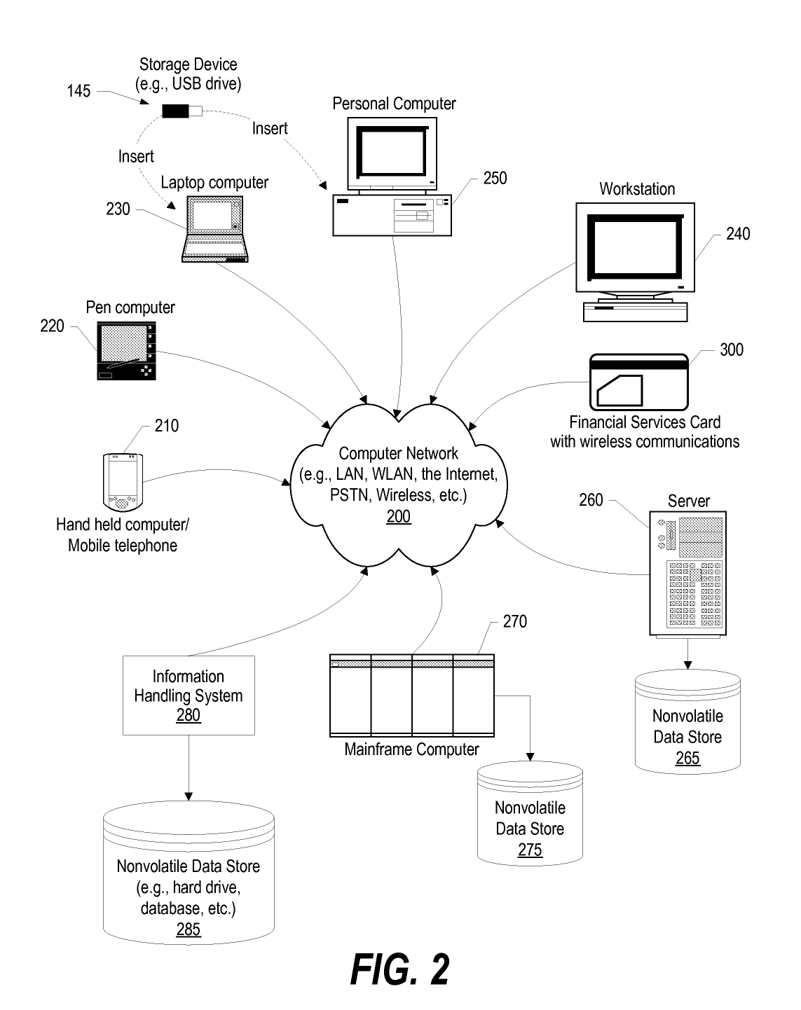

The following detailed description will generally follow the summary of the invention, as set forth above, further explaining and expanding the definitions of the various aspects and embodiments of the invention as necessary. To this end, this detailed description first sets forth a computing environment in FIG. 1 that is suitable to implement the software and/or hardware techniques associated with the invention. A networked environment is illustrated in FIG. 2 as an extension of the basic computing environment, to emphasize that modern computing techniques can be performed across multiple discrete devices.

FIG. 1 illustrates information handling system 100, which is a simplified example of a computer system capable of performing the computing operations described herein. Information handling system 100 includes one or more processors 110 coupled to processor interface bus 112. Processor interface bus 112 connects processors 110 to Northbridge 115, which is also known as the Memory Controller Hub (MCH). Northbridge 115 connects to system memory 120 and provides a means for processor(s) 110 to access the system memory. Graphics controller 125 also connects to Northbridge 115. In one embodiment, PCI Express bus 118 connects Northbridge 115 to graphics controller 125. Graphics controller 125 connects to display device 130, such as a computer monitor.

Northbridge 115 and Southbridge 135 connect to each other using bus 119. In one embodiment, the bus is a Direct Media Interface (DMI) bus that transfers data at high speeds in each direction between Northbridge 115 and Southbridge 135. In another embodiment, a Peripheral Component Interconnect (PCI) bus connects the Northbridge and the Southbridge. Southbridge 135, also known as the I/O Controller Hub (ICH) is a chip that generally implements capabilities that operate at slower speeds than the capabilities provided by the Northbridge. Southbridge 135 typically provides various busses used to connect various components. These busses include, for example, PCI and PCI Express busses, an ISA bus, a System Management Bus (SMBus or SMB), and/or a Low Pin Count (LPC) bus. The LPC bus often connects low-bandwidth devices, such as boot ROM 196 and “legacy” I/O devices (using a “super I/O” chip). The “legacy” I/O devices (198) can include, for example, serial and parallel ports, keyboard, mouse, and/or a floppy disk controller. The LPC bus also connects Southbridge 135 to Trusted Platform Module (TPM) 195. Other components often included in Southbridge 135 include a Direct Memory Access (DMA) controller, a Programmable Interrupt Controller (PIC), and a storage device controller, which connects Southbridge 135 to nonvolatile storage device 185, such as a hard disk drive, using bus 184.

ExpressCard 155 is a slot that connects hot-pluggable devices to the information handling system. ExpressCard 155 supports both PCI Express and USB connectivity as it connects to Southbridge 135 using both the Universal Serial Bus (USB) the PCI Express bus. Southbridge 135 includes USB Controller 140 that provides USB connectivity to devices that connect to the USB. These devices include webcam (camera) 150, infrared (IR) receiver 148, keyboard and trackpad 144, and Bluetooth device 146, which provides for wireless personal area networks (PANs). USB Controller 140 also provides USB connectivity to other miscellaneous USB connected devices 142, such as a mouse, removable nonvolatile storage device 145, modems, network cards, ISDN connectors, fax, printers, USB hubs, and many other types of USB connected devices. While removable nonvolatile storage device 145 is shown as a USB-connected device, removable nonvolatile storage device 145 could be connected using a different interface, such as a Firewire interface, etcetera.

Wireless Local Area Network (LAN) device 175 connects to Southbridge 135 via the PCI or PCI Express bus 172. LAN device 175 typically implements one of the IEEE .802.11 standards of over-the-air modulation techniques that all use the same protocol to wireless communicate between information handling system 100 and another computer system or device. Optical storage device 190 connects to Southbridge 135 using Serial ATA (SATA) bus 188. Serial ATA adapters and devices communicate over a high-speed serial link. The Serial ATA bus also connects Southbridge 135 to other forms of storage devices, such as hard disk drives. Audio circuitry 160, such as a sound card, connects to Southbridge 135 via bus 158. Audio circuitry 160 also provides functionality such as audio line-in and optical digital audio in port 162, optical digital output and headphone jack 164, internal speakers 166, and internal microphone 168. Ethernet controller 170 connects to Southbridge 135 using a bus, such as the PCI or PCI Express bus. Ethernet controller 170 connects information handling system 100 to a computer network, such as a Local Area Network (LAN), the Internet, and other public and private computer networks.

While FIG. 1 shows one information handling system, an information handling system may take many forms. For example, an information handling system may take the form of a desktop, server, portable, laptop, notebook, or other form factor computer or data processing system. In addition, an information handling system may take other form factors such as a personal digital assistant (PDA), a gaming device, ATM machine, a portable telephone device, a communication device or other devices that include a processor and memory.

The Trusted Platform Module (TPM 195) shown in FIG. 1 and described herein to provide security functions is but one example of a hardware security module (HSM). Therefore, the TPM described and claimed herein includes any type of HSM including, but not limited to, hardware security devices that conform to the Trusted Computing Groups (TCG) standard, and entitled “Trusted Platform Module (TPM) Specification Version 1.2.” The TPM is a hardware security subsystem that may be incorporated into any number of information handling systems, such as those outlined in FIG. 2.

FIG. 2 provides an extension of the information handling system environment shown in FIG. 1 to illustrate that the methods described herein can be performed on a wide variety of information handling systems that operate in a networked environment. Types of information handling systems range from small handheld devices, such as handheld computer/mobile telephone 210 to large mainframe systems, such as mainframe computer 270. Examples of handheld computer 210 include personal digital assistants (PDAs), personal entertainment devices, such as MP3 players, portable televisions, and compact disc players. Other examples of information handling systems include pen, or tablet, computer 220, laptop, or notebook, computer 230, workstation 240, personal computer system 250, and server 260. Other types of information handling systems that are not individually shown in FIG. 2 are represented by information handling system 280. As shown, the various information handling systems can be networked together using computer network 200. Types of computer network that can be used to interconnect the various information handling systems include Local Area Networks (LANs), Wireless Local Area Networks (WLANs), the Internet, the Public Switched Telephone Network (PSTN), other wireless networks, and any other network topology that can be used to interconnect the information handling systems. Many of the information handling systems include nonvolatile data stores, such as hard drives and/or nonvolatile memory. Some of the information handling systems shown in FIG. 2 depicts separate nonvolatile data stores (server 260 utilizes nonvolatile data store 265, mainframe computer 270 utilizes nonvolatile data store 275, and information handling system 280 utilizes nonvolatile data store 285). The nonvolatile data store can be a component that is external to the various information handling systems or can be internal to one of the information handling systems. In addition, removable nonvolatile storage device 145 can be shared among two or more information handling systems using various techniques, such as connecting the removable nonvolatile storage device 145 to a USB port or other connector of the information handling systems.

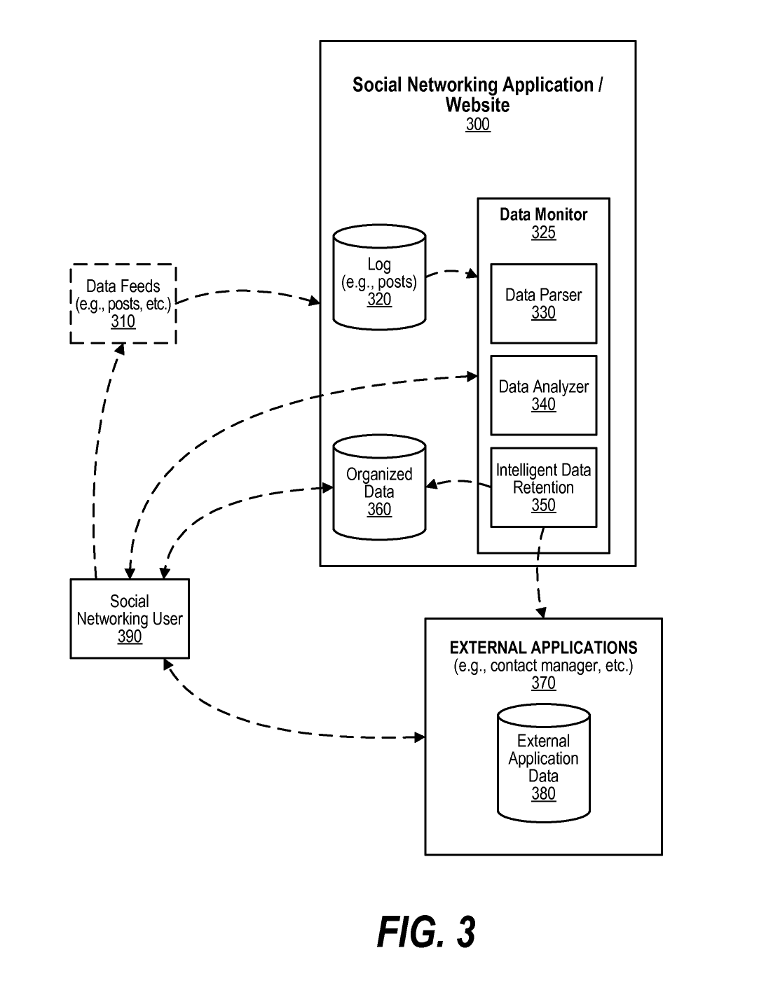

FIG. 3 is a block diagram depicting data feeds entering a social media website and a data monitor extracting and retaining useful information from the various feeds. The disclosure approach uses a system and method that analyzes social network feeds (e.g., “comments,” “posts,” “tweets,” etc. depending on the social network website/application being utilized. Social network feeds that include keywords such as “recommend”, “recommendation”, “company”, “person”, “need” and are followed by a comment or comments which contain contact information are recognized. Furthermore, identification of contact-oriented data is stored in a contact-oriented application (either within the social media website or external to the website) so that the user can more easily access and utilize the contact data in the future.

Social network website 300 includes a number of components that allow the users of the social network website to interact with each other. Interaction between users often uses data feeds 310 that are entered by users and directed to other users of the social network website. For example, data feeds can include comments, posts, messages, tweets, etc., depending on the functionality provided by the social network website. The social network website stores the various data feeds in data store 320. Data monitor 325 is an additional component added to the social network website that monitors the data feeds in order to identify contact data that might be included in some of the data feeds. In order to accomplish this task, data monitor 325 includes a number of subcomponents. These subcomponents include data parser 330 that parses the words in the data feeds so that individual words can be analyzed. Another subcomponent that is included is data analyzer 340 that analyzes the words included in data feeds with various keywords. Finally, intelligent data retention subcomponent 350 is a subcomponent that stores the contact data identified in the data feeds. The contact data can be stored in data store 360, which is part of the social network website such as a contact app that is included in the social network website, as well as in external applications 370, such as an external website used for contact management or an application residing on the user's information handling system (e.g., personal information manager (PIM), etc.). External applications 370 stores the contact data on external data store 380 which is outside of the social network website.

Social network user 390 utilizes social network website 300 using the interfaces provided by the website, such as those that allow the user to submit data feeds to the website. In addition, as described in more detail herein, social network user 390 interacts with data monitor 325, such as in setting up a configuration, interacting with dialogs that enter data in the user's contact-oriented applications, as well as adding calendar data to the user's computer-based calendar (e.g., maintained by the social network website or by one of the external applications, etc.). Once contact data has been extracted from data feeds and used to enter new contact data into the contact-oriented applications, user 390 can access the contact data utilizing the contact-oriented applications.

Using the process described herein, recognition of text that contains a contact information (e.g., business name, person name, etc.) and the contact information for that business, which is being shared on a social media website is recognized by the data monitor as a contact, such as in a referral or business recommendation. Once the recognition takes place, the data monitor provides facilities to share or store the information within the social media website or in another application external to the social media website. This approach allows for contact information (e.g., business references, etc.) that can be shared within an application with other users (e.g., in an online referral or recommendation system, etc.). In addition, contact information can be stored by the user as structured data for future reference without having to scroll though old postings or having to copy/paste the text outside of the originating application. Also, the user can interact with the information (e.g., selecting the contact with a click, etc.) from within the originating social media website (i.e. click the associated fan page, or website link, or dial the contact number from a mobile telephone, etc.).

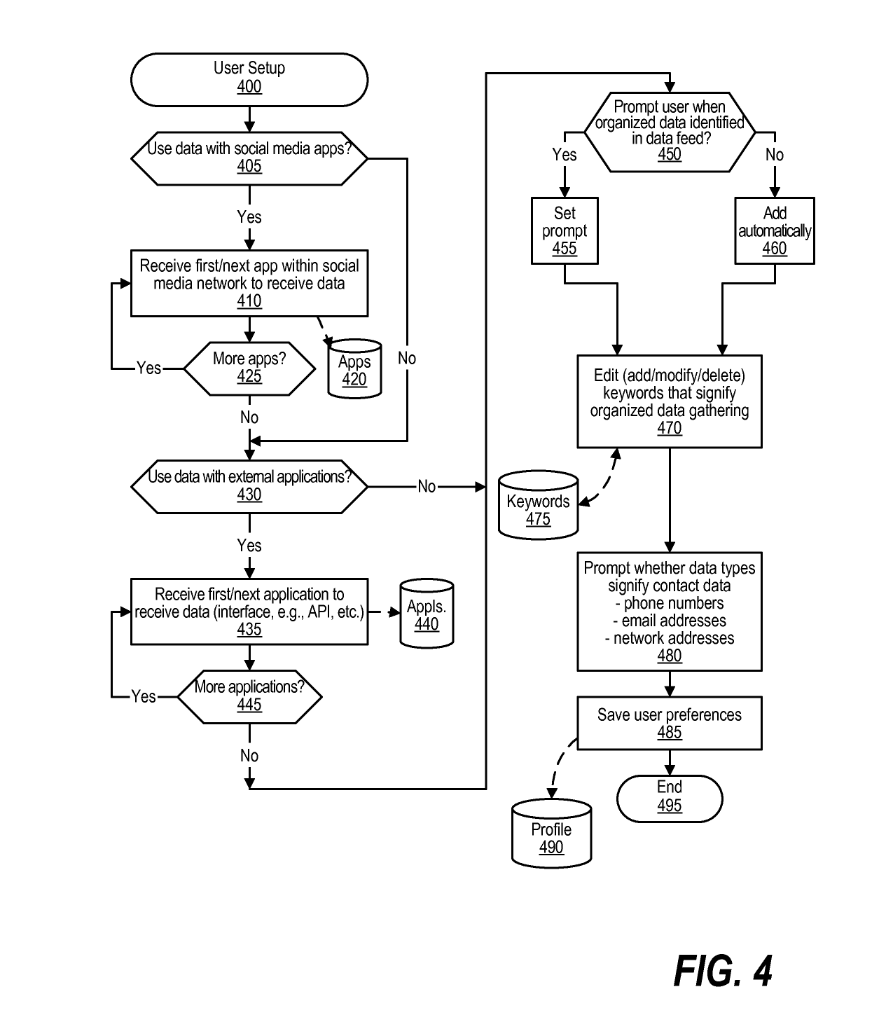

FIG. 4 is a flowchart depicting steps taken by a user to setup the data monitor functionality. User setup processing commences at 400 whereupon various input is received from the user regarding the user's preferences, such as using a dialog with radio buttons, checkboxes, etc. to receive such preferences. A decision is made as to whether the user wishes to use contact data with social media apps that run in the social network website (contact-oriented applications), such as a contact manager that is included in the social network website (decision 405). If the user wishes to use contact data with social media apps, then decision 405 branches to the “yes” branch whereupon, at step 410 the first social media app within the social network website that is to receive extracted contact data is received from the user (e.g., using a list or combo box of available social media apps that can utilize contact data). The received social media app is then stored in social media apps data store 420. A decision is made as to whether the user wishes to use contact data with additional social media apps (decision 425). If the user wishes to use the contact data with additional social media apps, then decision 425 branches to the “yes” branch which loops back to step 410 to receive and store the next social media app that is to receive contact data. This looping continues until there are no more social media apps to receive contact data, at which point decision 425 branches to the “no” branch for further setup processing. Returning to decision 405, if the user does not wish to use contact data with social media apps, then decision 405 branches to the “no” branch bypassing the processing used to receive the social media apps from the user.

A decision is made as to whether the user wishes to transmit extracted contact data to external applications outside of the social network website (decision 430). Contact-oriented applications that are external to the social network website may include applications residing on other websites used by the user to manage contact data or on applications running on one of the user's information handling systems (e.g., a desktop computer, a laptop, a smart phone, etc.). If the user wishes to use contact data with external contact-oriented applications, then decision 430 branches to the “yes” branch whereupon, at step 435 the first external contact-oriented application that is to receive extracted contact data is received from the user (e.g., using a list or combo box of available social media apps that can utilize contact data). In addition, the programming interface such as a Simple Object Access Protocol (SOAP), an Application Programming Interface (API), etc.) is identified in order for the social network website to interface with the external application. The received external application is then stored in external applications data store 440. A decision is made as to whether the user wishes to use contact data with additional external contact-oriented applications (decision 445). If the user wishes to use the contact data with additional external contact-oriented applications, then decision 445 branches to the “yes” branch which loops back to step 435 to receive and store the next external contact-oriented applications (and appropriate programming interface) that is to receive contact data. This looping continues until there are no more social media apps to receive contact data, at which point decision 445 branches to the “no” branch for further setup processing. Returning to decision 430, if the user does not wish to use contact data with external contact-oriented applications, then decision 430 branches to the “no” branch bypassing the processing used to receive the external contact-oriented applications from the user.

A decision is made as to whether the user wishes to be prompted when contact data is identified in a data feed before adding the extracted contact data to the user's contact-oriented applications (decision 450). If the user wishes to be prompted, then decision 450 branches to the “yes” branch whereupon, at step 455, the user profile data is set to prompt the user when contact data is extracted from a social network feed. On the other hand, if the user does not wish to be prompted, then decision 450 branches to the “no” branch whereupon, at step 460, the user profile data is set to automatically extract and add the contact data to the user's selected contact-oriented applications without prompting the user. In one embodiment, the user can select to have the contact data automatically added to some selected contact-oriented applications while being prompted before the contact data is added to other selected contact-oriented applications.

At step 470, the user is presented with default keywords that are used to identify contact data within social network feeds. During this step, the user edits the list of keywords stored in data store 475. The user can delete keywords, add new keywords, and modify existing keywords. The user's edited keywords are stored in data store 475 for subsequent retrieval and use when the social network website analyzes data feeds in order to extract contact data.

Some types of contact data can be identified because of a format of the data rather than the specific words used in the data feed. For example, phone numbers, email addresses, and network addresses can be identified based on the format of the data (e.g., hyphens and/or parentheses in phone numbers, etc.). At step 480, the user is prompted as to what formats of data signify contact data information in a data feed. The types of data can include phone numbers, email addresses, network addresses, and user-specified formats (e.g., input using format codes, etc.). At step 485, all of the user preferences gathered in FIG. 4 are stored to profile data store 490 within the social network website. Processing then ends at 495.

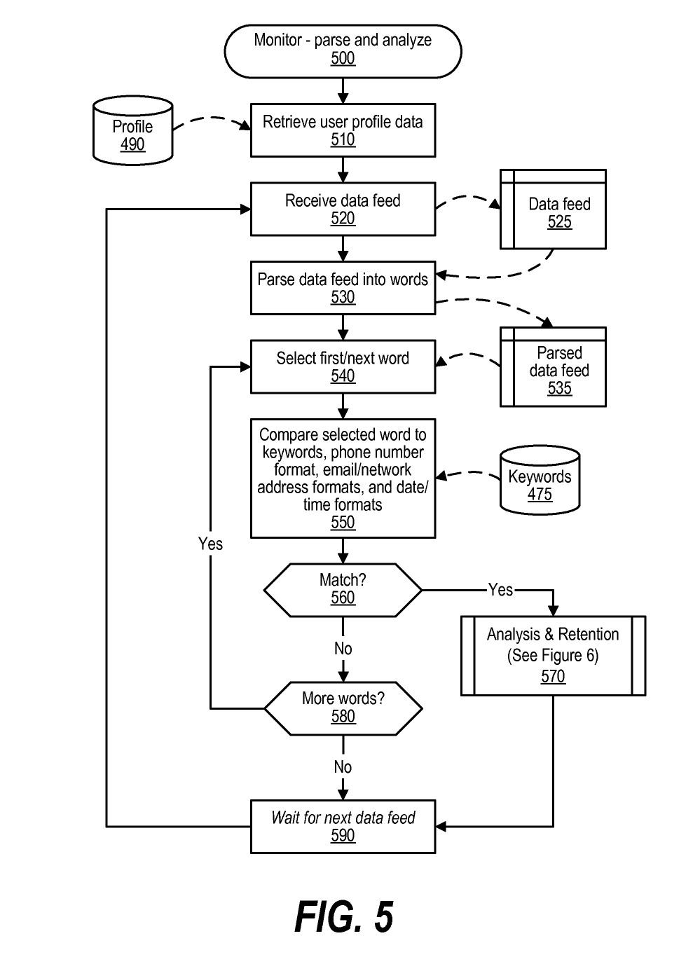

FIG. 5 is a flowchart depicting steps taken by the data monitor to parse and analyze data feeds. Monitor processing commences at 500 whereupon, at step 510, the user's profile data, that was gathered as shown in FIG. 4, is retrieved from data store 490. At step 520, a data feed is received that pertains to the user (e.g., a comment, tweet, post, etc.). The data feed is stored in data feed memory area 525. At step 530, the data feed is parsed into individual words for processing and the individual words are stored in memory area 535.

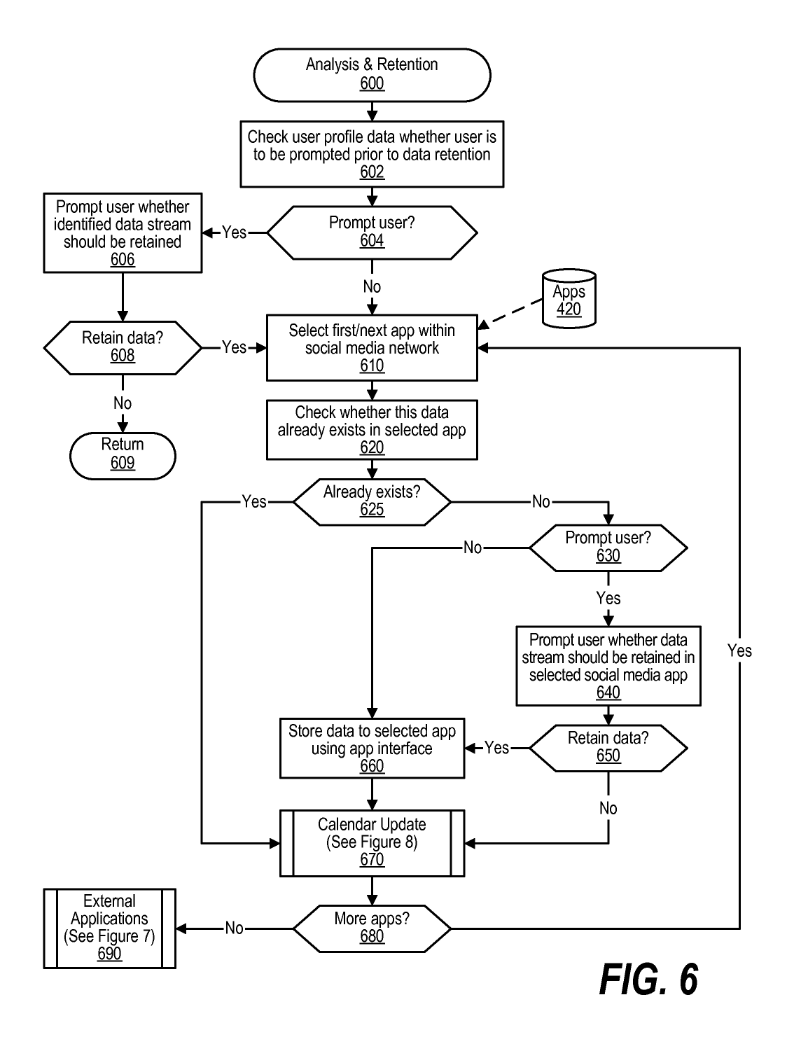

At step 540, the first word from the data feed is selected from memory area 535. At step 550, the selected word is compared to keywords from keywords data store 475. As used herein, keywords also includes keyword formats, such as telephone number formats, email address formats, date/time formats, network address formats, and the like. A decision is made as to whether the selected word matches one of the keywords (including one of the keyword formats) at decision 560. If the selected word matches a keyword, then decision 560 branches to the “yes” branch whereupon predefined process 570 is performed to analyze and possibly retain contact-related data that can be extracted from the data feed (see FIG. 6 and corresponding text for processing details). On the other hand, if the selected word does not match one of the keywords, then decision 560 branches to the “no” branch where another decision is made as to whether there are more words in the data feed to process (decision 580). If there are more words in the data feed to process, then decision 580 branches to the “yes” branch which loops back to select and analyze the next word in the data feed as described above. This looping continues until either a keyword is found or until there are no more words in the data feed to process. When there are no more words in the data feed to process, then decision 580 branches to the “no” branch whereupon, at step 590, the monitor process waits for the next data feed to arrive that pertains to the user. When the next data feed arrives, step 590 loops back to step 520 to receive and process the data feed as described above.

FIG. 6 is a flowchart depicting steps taken by the data monitor to analyze and retain useful data extracted from the data feeds. Processing commences at 600 whereupon, at step 602, the user's profile (configuration) data is checked to determine whether the user has requested to be prompted before retaining data from a data feed (decision 604). If the user is to be prompted, then decision 604 branches to the “yes” branch whereupon, at step 606, the user is prompted as to whether the user wishes to retain data from the identified data feed (decision 608). If the user indicates that he/she does not wish to retain data from the data feed, then decision 608 branches to the “no” branch and processing returns to the calling routine (see FIG. 5) without adding any contact data to any of the user's contact-oriented applications.

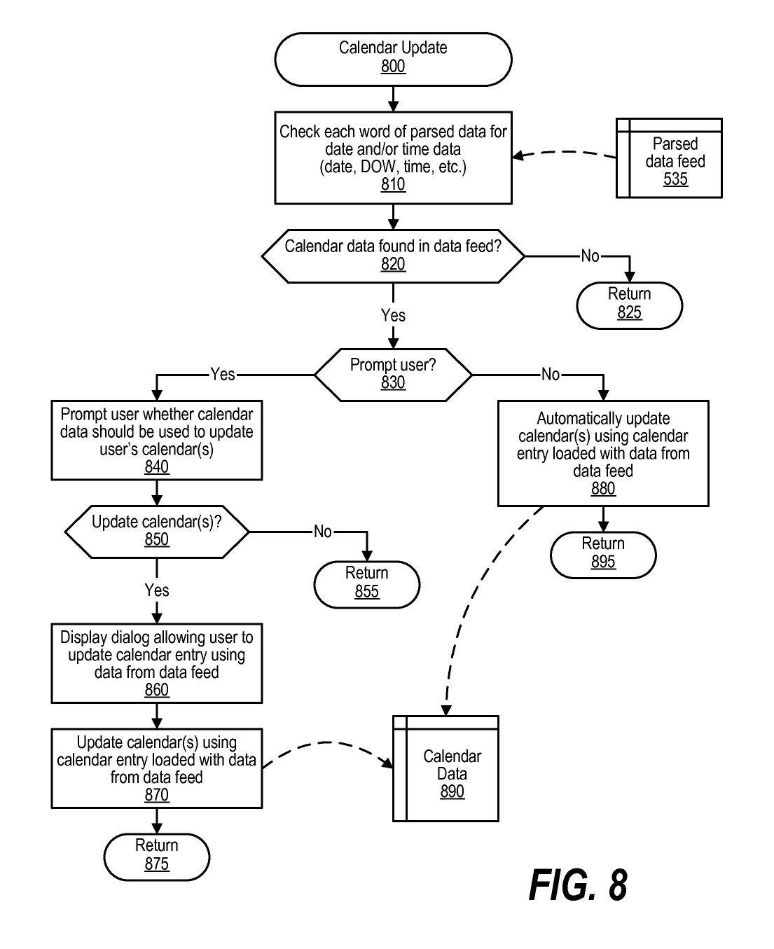

On the other hand, if either the user does not wish to be prompted (decision 604 branching to the “no” branch) or if the prompted user indicated that he/she did wish to retain data from the data feed (decision 608 branching to the “yes” branch), then, at step 610, the first app identified within the social network website is selected from data store 420. At step 620, the process checks to determine whether the identified contact data already exists in the selected social network website app (decision 625). If the contact data already exists in the selected social network website app, then decision 625 branches to the “yes” branch for possible calendar update processing at predefined process 670 (see FIG. 8 and corresponding text for processing details). On the other hand, if the contact data does not exist in the selected social network website app, then decision 625 branches to the “no” branch whereupon a decision is made as to whether the profile data indicates that the user has requested to be prompted before the selected social network website is updated (decision 630). If the user has requested to be notified before updating the selected social network website app, then decision 630 branches to the “yes” branch whereupon, at step 640, the user is prompted as to whether he/she wishes to use the identified data feed to update the selected social network website app (decision 650). If the user is prompted and requests to retain data from the data feed (decision 650 branching to the “yes” branch) or if the user has not requested to be prompted before updating the selected social network website app (decision 630 branching to the “no” branch), then, at step 660, the contact data extracted from the selected data feed is used to update the selected social network website app. In one embodiment, the user, if requested in the profile, is presented with a dialog so that any contact data not found in the data feed that might be known by the user can be added to the entry being added to the social network website app. On the other hand, if the user is prompted and requests not to update the selected social network website, then decision 650 branches to the “no” branch bypassing step 660.

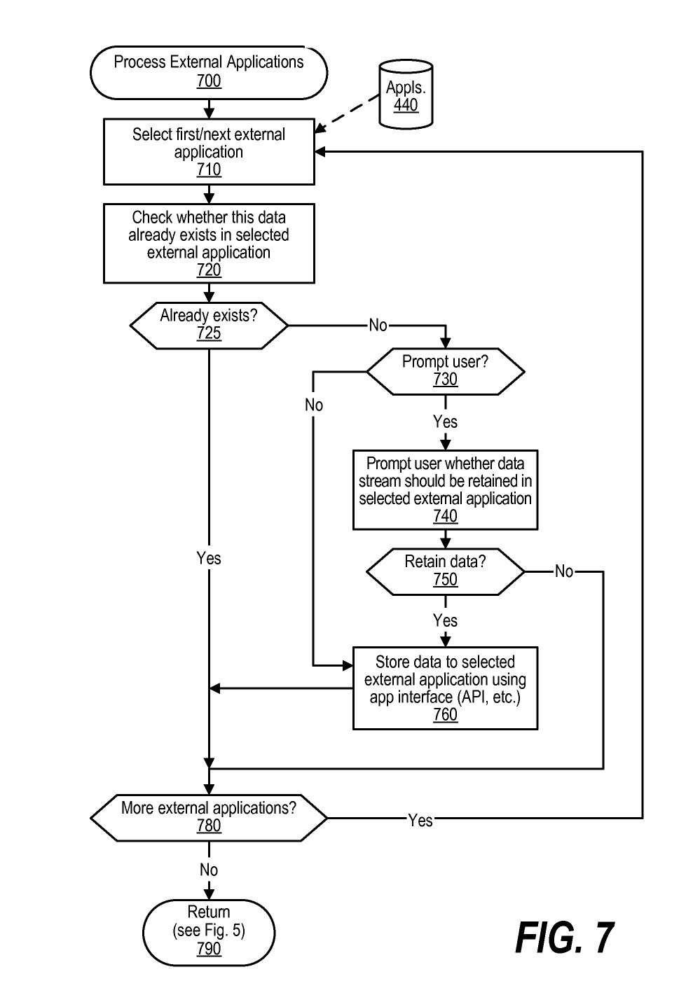

At predefined process 670, a calendar update process is performed in order to extract any date/time data from the data feed that might possibly be used to update the user's calendar application (see FIG. 8 and corresponding text for processing details). A decision is made as to whether there are more social network website apps that are contact-oriented and may need to be updated using the current data feed (decision 680). If there are more social network website apps to process, then decision 680 branches to the “yes” branch which loops back to select and process the next social network website app as discussed above. This looping continues until all of the social network website apps selected by the user during the setup process have been processed and possibly updated as discussed above. When all of the social network website apps selected by the user have been processed, then decision 680 branches to the “no” branch whereupon, at predefined process 690, any external contact-oriented applications are processed (see FIG. 7 and corresponding text for processing details).

The approach described in FIG. 6 allows contact data (e.g., important business referral information, business references, etc.) to become dynamic rather than static data feeds. In addition, the contact data gathered from data feeds can be used both within the social media website in which the information is identified in a data feed, as well as within applications (e.g., web-based, desktop, etc.), such as contact management applications and can be used in a variety of environments. For example, the person seeking the information might be a sales lead, so the contact data can be retrieved and stored for future sales purposes. In another example, the person referring the contact (e.g., the “referrer”) is now available to be contacted by the referring business (e.g., appreciation, finder benefits, etc.) In another example, the contact data is made available by the referrer for future reference either as a bookmark in a browser software application or in an application within the social media website or in an external application (e.g., web-based, on a desktop computer, using a third party tool accessing this information such as from a mobile device, etc.). In one embodiment, such as in use in a reference or recommendation website, the contact data and remarks about the contact can be accessed by the business in the form of referral statistics for use by the business in marketing, sales or other business related activity. For example, once the “business referral” context is recognized by the tool and posted to a website, such as reference or referral website, the contact (e.g., a business that is being referred) can collect statistics regarding positive and negative recommendations as well as extrapolate sales leads from the data.

FIG. 7 is a flowchart depicting steps taken to provide extracted data to external applications outside of the social media website. At step 710, the first external contact-oriented application that was setup by the user during setup processing is selected from data store 440. At step 720, the process checks to determine whether the identified contact data already exists in the selected external contact-oriented application (decision 725). If the contact data already exists in the selected external contact-oriented application, then decision 725 branches to the “yes” bypassing the remaining steps used to process the external contact-oriented application. On the other hand, if the contact data does not exist in the selected external contact-oriented application, then decision 725 branches to the “no” branch whereupon a decision is made as to whether the profile data indicates that the user has requested to be prompted before the selected external contact-oriented application is updated (decision 730). If the user has requested to be notified before updating the selected external contact-oriented application, then decision 730 branches to the “yes” branch whereupon, at step 740, the user is prompted as to whether he/she wishes to use the identified data feed to update the selected external contact-oriented application (decision 750). If the user is prompted and requests to retain data from the data feed (decision 750 branching to the “yes” branch) or if the user has not requested to be prompted before updating the selected external contact-oriented application (decision 730 branching to the “no” branch), then, at step 760, the contact data extracted from the selected data feed is used to update the selected external contact-oriented application using the programming interface (e.g., API, SOAP, etc.) found in data store 440. In one embodiment, the user, if requested in the profile, is presented with a dialog so that any contact data not found in the data feed that might be known by the user can be added to the entry being added to the external contact-oriented application. On the other hand, if the user is prompted and requests not to update the selected external contact-oriented application, then decision 750 branches to the “no” branch bypassing step 760.

A decision is made as to whether the user has set up additional external contact-oriented applications to which the user wants to update using contact data from data feeds (decision 780). If the user has set up additional external contact-oriented applications, then decision 780 branches to the “yes” branch which loops back to select and process the next external contact-oriented application as described above. When all of the external contact-oriented applications have been processed, then decision 780 branches to the “no” branch whereupon processing returns to the calling routine (see FIG. 5) at 790.

FIG. 8 is a flowchart showing steps performed in extracting calendar-related information from a data feed to update the user's computer-based calendar.

Processing commences at 800 whereupon, at step 810, the words in the data feed (stored in memory area 535) are checked for any date and/or time indications (e.g., “pm”, “am”, hh:mm, yy/mm/dd, etc.). A decision is made as to whether any possible calendar data is found in the data feed (decision 820). If no calendar data is found in the data feed, then decision 820 branches to the “no” branch whereupon processing returns to the calling routine (see FIG. 6) at 825.

On the other hand, if calendar data is found in the data feed, then decision 820 branches to the “yes” branch whereupon a decision is made as to whether the user has indicated in the profile data to be prompted before updating the user's calendar (decision 830). If the user has requested to be prompted before updating the calendar, then decision 830 branches to the “yes” branch whereupon, at step 840, a dialog is displayed prompting the user as to whether to update the user's calendar with data extracted from the data feed. A decision is made as to whether the user has requested to have the calendar updated (decision 850). If the user does not wish to update the calendar using the data from the data feed, then decision 850 branches to the “no” branch whereupon processing returns to the calling routine (see FIG. 6) at 855.

On the other hand, if the user has requested to use the data from the data feed to update the user's calendar, then decision 850 branches to the “yes” branch whereupon, at step 860, a dialog is displayed allowing the user to edit the calendar entry using data extracted from the data feed. At step 870, the user's calendar (calendar data 890) is updated using the calendar data extracted from the data feed. Processing then returns to the calling routine (see FIG. 6) at 875.

Returning to decision 830, if the user requested to have calendar entries updated automatically, then decision 830 branches to the “no” branch whereupon, at step 880, the user's calendar (calendar data 890) is updated with an entry automatically generated using data extracted from the data feed. Processing then returns to the calling routine (see FIG. 6) at 895.

In one embodiment, the calendar application is an app within the social network website. In this embodiment, the data extracted from the data feed is stored in the calendar data area of the social network website. In another embodiment, the calendar application is an external application (e.g., residing on another website or on an information handling system accessible by the user, etc.). In this embodiment, a programming interface pertaining to the calendar (e.g., API, SOAP, etc.) is retrieved and used to push the calendar data to the external calendar application and update the calendar accordingly.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, any suitable combination of the foregoing, or a future developed computer readable storage medium. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). The connection may be physical or wireless.

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

What is claimed is:

1. A method implemented by an information handling system comprising:
receiving, at a network interface, a plurality of social network feeds, wherein each of the feeds is a freeform comment;
identifying, using a processor, a keyword in a selected one of the received social network feeds, wherein the keyword identifies the selected social network feed as including contact data;
extracting contact data from the selected social network feed; and
storing the extracted contact data in a contact-oriented application.

2. The method of claim 1 wherein the contact-oriented application is a social network application running on a social network website that received the plurality of social network feeds.

3. The method of claim 1 wherein the contact-oriented application is a calendar application, and wherein the method further comprises:
extracting a time-oriented data from the selected data feed;
creating a calendar entry using the extracted time-oriented data; and
updating the calendar application with the calendar entry.

4. The method of claim 3 further comprising:
displaying a dialog that includes the extracted time-oriented data;
receiving one or more calendar entry updates from a user of the information handling system; and
updating the calendar entry with the received calendar entry updates.

5. The method of claim 1 wherein the contact-oriented application is an external contact-oriented application that is external from a social network website that received the plurality of social network feeds, the method further comprising:
retrieving a programming interface corresponding to the external contact-oriented application; and
pushing the extracted contact data to the external contact-oriented application using the retrieved programming interface.

6. The method of claim 1 further comprising:
retrieving a keyword list from a data store, wherein the keyword list includes a plurality of keywords;
parsing each of the data feeds into a plurality of words;
matching the plurality of words against the plurality of keywords, wherein the identified keyword is a match of one of the words in the selected social network feed with one of the plurality of keywords; and
identifying whether the extracted contact data already exists in the contact-oriented application, wherein the storing is performed in response to the extracted contact data not being found in the contact-oriented application.

7. The method of claim 1 wherein the contact-oriented application is a referral application, the method further comprising:
posting the extracted contact data in the referral application viewable by a plurality of users;
receiving recommendation comments pertaining to the posted contact data from one or more of the plurality of users; and
storing the recommendation comments in the referral application and associating the recommendation comments with the posted contact data.

8. An information handling system included in a financial services card, wherein the information handling system comprises:
one or more processors;
a memory coupled to at least one of the processors; and
a set of instructions stored in the memory and executed by at least one of the processors, wherein the set of instructions perform actions of:
receiving a plurality of social network feeds, wherein each of the feeds is a freeform comment;
identifying a keyword in a selected one of the received social network feeds, wherein the keyword identifies the selected social network feed as including contact data;
extracting contact data from the selected social network feed; and
storing the extracted contact data in a contact-oriented application.

9. The information handling system of claim 8 wherein the contact-oriented application is a social network application running on a social network website that received the plurality of social network feeds.

10. The information handling system of claim 8 wherein the contact-oriented application is a calendar application, and wherein the wherein the actions further comprise:
extracting a time-oriented data from the selected data feed;
creating a calendar entry using the extracted time-oriented data; and
updating the calendar application with calendar entry.

11. The information handling system of claim 10 wherein the actions further comprise:
displaying a dialog that includes the extracted time-oriented data;
receiving one or more calendar entry updates from a user of the information handling system; and
updating the calendar entry with the received calendar entry updates.

12. The information handling system of claim 8 wherein the contact-oriented application is an external contact-oriented application that is external from a social network website that received the plurality of social network feeds, and wherein the actions further comprise:
retrieving a programming interface corresponding to the external contact-oriented application; and
pushing the extracted contact data to the external contact-oriented application using the retrieved programming interface.

13. The information handling system of claim 8 wherein the actions further comprise:
retrieving a keyword list from a data store, wherein the keyword list includes a plurality of keywords;
parsing each of the data feeds into a plurality of words;
matching the plurality of words against the plurality of keywords, wherein the identified keyword is a match of one of the words in the selected social network feed with one of the plurality of keywords; and
identifying whether the extracted contact data already exists in the contact-oriented application, wherein the storing is performed in response to the extracted contact data not being found in the contact-oriented application.

14. The information handling system of claim 8 wherein the actions further comprise:
posting the extracted contact data in the referral application viewable by a plurality of users;
receiving recommendation comments pertaining to the posted contact data from one or more of the plurality of users; and
storing the recommendation comments in the referral application and associating the recommendation comments with the posted contact data.

15. A computer program product stored in a computer readable medium, comprising functional descriptive material that, when executed by an information handling system, causes the information handling system to perform actions comprising:
receiving a plurality of social network feeds, wherein each of the feeds is a freeform comment;
identifying a keyword in a selected one of the received social network feeds, wherein the keyword identifies the selected social network feed as including contact data;
extracting contact data from the selected social network feed; and
storing the extracted contact data in a contact-oriented application.

16. The computer program product of claim 15 wherein the contact-oriented application is a social network application running on a social network website that received the plurality of social network feeds.

17. The computer program product of claim 15 wherein the contact-oriented application is a calendar application, and wherein the actions further comprise:
extracting a time-oriented data from the selected data feed;
creating a calendar entry using the extracted time-oriented data; and
updating the calendar application with the calendar entry.

18. The computer program product of claim 17 wherein the actions further comprise:
displaying a dialog that includes the extracted time-oriented data;
receiving one or more calendar entry updates from a user of the information handling system; and
updating the calendar entry with the received calendar entry updates.

19. The computer program product of claim 15 wherein the contact-oriented application is an external contact-oriented application that is external from a social network website that received the plurality of social network feeds, and wherein the actions further comprise:
retrieving a programming interface corresponding to the external contact-oriented application; and
pushing the extracted contact data to the external contact-oriented application using the retrieved programming interface.

20. The computer program product of claim 15 wherein the actions further comprise:
retrieving a keyword list from a data store, wherein the keyword list includes a plurality of keywords;
parsing each of the data feeds into a plurality of words;
matching the plurality of words against the plurality of keywords, wherein the identified keyword is a match of one of the words in the selected social network feed with one of the plurality of keywords; and
identifying whether the extracted contact data already exists in the contact-oriented application, wherein the storing is performed in response to the extracted contact data not being found in the contact-oriented application.
